(19) United States
(12) Patent Application Publication
(10) Pub. No.: US 2007/0066730 A1
(43) Pub. Date: Mar. 22, 2007

(54) Organic elastomer silicone vulcanizates

(76) Inventors: Igor Chorvath, Midland, MI (US); Lauren Tonge, Sanford, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/578,982

(22) PCT Filed: Dec. 13, 2004
(86) PCT No.: PCT/US04/41625

§ 371 Date: May 11, 2006

Related U.S. Application Data
(60) Provisional application No. 60/529,527, filed on Dec. 15, 2003.
(60) Provisional application No. 60/529,651, filed on Dec. 15, 2003.
(60) Provisional application No. 60/529,518, filed on Dec. 15, 2003.

(51) Int. Cl. B60C 1/00

(52) U.S. Cl. 524/261

(57) ABSTRACT

A method for making an organic elastomeric base composition comprising an organic elastomer and silicone, the product prepared by the method, and the cured organic rubber obtained therefrom is disclosed. The method comprises; (I) mixing (A) an organic elastomer with (B) an optional compatibilizer, (C) an optional catalyst, (D) a silicone base comprising a curable organopolysiloxane, (E) an optional crosslinking agent, (F) a cure agent in an amount sufficient to cure said organopolysiloxane; and (II) dynamically vulcanizing the organopolysiloxane, wherein the weight ratio of organic elastomer (A) to silicone base (D) in the elastomeric base composition ranges from 95:5 to 30:70.

The present invention relates to a method of making an organic elastomeric base composition comprising an organic elastomer and silicone, the product prepared by the method, and the cured organic rubber obtained therefrom.

A need exists to modify organic elastomers in an efficient manner to improve their performance at temperature extremes. In particular, there is a need to provide organic elastomer compositions for use in various applications where high and or low temperature properties are required. A need also exists to modify organic elastomers in an efficient manner to improve their processing.

There have been relatively few successful attempts to provide modified organic elastomers by the addition of, or combination with, siloxane based polymers. Stable uniform mixtures are difficult to obtain due to the incompatibility of organic elastomers with siloxane based polymers. Moreover, blends must be co-crosslinkable. Some representative examples to provide organic elastomer and silicone elastomer compositions include U.S. Pat. Nos. 4,942,202, 5,171,787 and 5,350,804.

U.S. Pat. No. 4,942,202 teaches a rubber composition and vulcanized rubber-products, which included fluorocarbons. The '202 compositions are prepared by reacting an organic peroxide, under shear deformation, with (I) a silicone rubber, (II) a saturated elastomer that fails to react with an organic peroxide when it is used alone, and (III) another elastomer that is co-crosslinkable with the silicone rubber in the presence of an organic peroxide. The other elastomer (III) is also co-crosslinkable or highly miscible with component (II).

U.S. Pat. No. 5,171,787 teaches silicone-based composite rubber compositions, including organic elastomers, and uses thereof. The '787 compositions are prepared by compounding a (A) rubber forming polymer comprising a polyorganosiloxane and an organic rubber, (B) a silicon compound having at least two hydrolyzable groups per molecule, and (C) a heavy metal compound, amine, or quaternary ammonium salt which catalyzes the hydrolysis and condensation reaction; and allowing the resulting formulation to undergo hydrolysis and condensation reactions while the formulation is kept from being deformed by shearing; and a crosslinking agent subsequently added followed by crosslinking of said organic rubber.

U.S. Pat. No. 5,350,804 teaches a composite rubber composition which comprises (a) an organic rubbery elastomer composition have a Mooney viscosity of at least 70 at 100° C. forming the matrix phase of the composite rubber composition; and (b) cured silicone rubber as a dispersed phase in the matrix phase.

The present invention provides organic elastomeric base compositions based on the incorporation of silicones with organic elastomers using a dynamic vulcanization process. These organic elastomeric base compositions result from the new mixing processes of the present invention. These new mixing processes provide compositions having significant quantities of a silicone rubber based composition incorporated into an organic elastomer. However, the resulting cured organic rubber composition prepared from the organic elastomeric base compositions of the present invention, maintain many of the desirable physical property attributes of the organic elastomer.

This invention provides a method for preparing an organic elastomeric base composition containing both an organic elastomer and a silicone wherein a silicone base is mixed with an organic elastomer, and the silicone base is dynamically vulcanized within the organic elastomer. Thus, the present invention relates to a method for preparing an elastomeric base composition comprising:

(I) mixing
(A) an organic elastomer with
(B) an optional compatibilizer,
(C) an optional catalyst,
(D) a silicone base comprising a curable organopolysiloxane,
(E) an optional crosslinking agent,
(F) a cure agent in an amount sufficient to cure said organopolysiloxane; and

(II) dynamically vulcanizing the organopolysiloxane,
wherein the weight ratio of organic elastomer (A) to silicone base (D) in the elastomeric base composition ranges from 95:5 to 30:70.

Preferably, mixing is performed via an extrusion process. The order of mixing of components (A) through (F) is not critical. The order of mixing components (A) through (F) may occur via two preferred embodiments as taught herein. In a first embodiment, components (A), (B), and (C) are first mixed to form a “modified organic elastomer”, which is then subsequently mixed with components (D), (E), and (F). In a second embodiment, components (D), (E) and (F) are first mixed to form a “silicone compound”, which is then subsequently mixed with components (A), (B), and (C).

The invention further relates to the elastomer base compositions obtained by the present method and cured organic elastomeric compositions and articles prepared therefrom.

(A) Organic Elastomer

Component (A) is an organic elastomer having a glass transition temperature (T_{g}) below room temperature, alternatively below 23° C., alternatively, below 15° C., alternatively below 0° C. “Glass transition temperature”, means the temperature at which a polymer changes from a glassy vitreous state to a rubbery state. The glass transition temperature can be determined by conventional methods, such as Dynamic Mechanical Analysis (DMA) and Differential Scanning Calorimetry (DSC). As used herein, an “organic elastomer” excludes fluorocarbon and silicone based elastomers. The organic elastomeric component (A) can be selected from any of the major classes of organic elastomers and rubbers (ASTM nomenclature shown in parentheses) that are known in the art as natural rubber (NR), isoprene rubber (IR), styrene-butadiene rubber (SBR), butadiene rubber (BR), chloroprene rubber (CR), chlorinated polyethylene (CPE), butyl rubber, acrylonitrile-butadiene rubber (NBR), chlorosulfonated polyethylene (CSM), acrylic rubber (ACM), epichlorohydrin rubber (ECO), ethylene-vinyl acetate rubber (EVM), ethylene-acrylic rubber, ethylene-α-olefin copolymerized rubber, ethylene-α-olefin-diene terpolymerized rubber (EPDM), and hydrogenated nitrile rubber (HNBR).

Alternatively, the organic elastomer is a high performance elastomer selected from chlorosulfonated polyethylene (CSM), chlorinated polyethylene (CPE/CM), ethylene-vinyl acetate rubber (EVM), epichlorohydrin rubber (ECO), hydrogenated nitrile rubber (HNBR), and acrylic rubber (ACM). Alternatively, the organic elastomer is an ethylene-α-olefin-diene terpolymerized rubber (EPDM).

In the chemically modified organic elastomer embodiment described infra, (A) is selected from a organic elastomer comprising an organic polymer that can react with the compatibilizer (B) to produce a modified organic elastomer. It is anticipated that the organic elastomer, component (A), can be a mixture of organic polymers. However in the chemically modified organic elastomer embodiment, at least 2 wt. %, alternatively at least 5 wt. %, or alternatively at least 10% of the organic elastomer composition should contain an organic polymer having a reactive group capable of reacting with the compatibilizer (B).

(B) Compatilibilizer

Compatibilizer (B) can be selected from any hydrocarbon, organosiloxane, fluorocarbon, or combinations thereof that would be expected to modify the organic elastomer or the silicone base in a manner to enhance the mixing of the silicone base (D) with the organic elastomer (A) to produce a mixture having a continuous organic phase and a discontinuous (i.e. internal) silicone phase. Typically, the compatibilizer may be one of two types. In a first embodiment, herein referred to as a physical compatibilizer, the compatibilizer is selected from any hydrocarbon, organosiloxane, fluorocarbon, or combinations thereof, that would not be expected to react with the organic elastomer (A) or the silicone base (D), yet still enhance the mixing of the organic elastomer with the silicone base. In a second embodiment herein referred to as a chemical compatibilizer, the compatibilizer is selected from any hydrocarbon, organosiloxane, or fluorocarbon or combinations thereof that could react chemically with the organic elastomer or the silicone base. However in either embodiment, the compatibilizer must not prevent the dynamic cure of the organopolysiloxane component, described infra.

In the physically modified organic embodiment, the compatibilizer (B) can be selected from any compatibilizer known in the art to enhance the mixing of a silicone base with an organic elastomer. Typically, such compatibilizers are the reaction product of a organopolysiloxane and an organic polymer.

In the chemically modified organic embodiment, typically the compatibilizer (B) can be selected from (B′) organic (i.e., non-silicone) compounds which contain 2 or more olefin groups, (B″) organopolysiloxanes containing at least 2 alkenyl groups, (B′″) olefin-functional silanes which also contain at least one hydrolyzable group or at least one hydroxyl group attached to a silicon atom thereof, (B″″) an organopolysiloxane having at least one organofunctional groups selected from amine, amide, isocyanurate, phenol, acrylate, epoxy, and thiol groups, and any combinations of (B′), (B″), (B′″), and (B″″).

Organic compatibilizer (B′) can be illustrated by compounds such as diallyphthalate, triallyl isocyanurate, 2,4,6-triallyloxy-1,3,5-triazine, triallyl trimesate, 1,5-hexadiene, low molecular weight polybutadienes, 1,7-octadiene, 2,2′-diallylbisphenol A, N,N′-diallyl tartardiamide, diallylurea, diallyl succinate and divinyl sulfone, inter alia

Compatibilizer (B″) may be selected from linear, branched or cyclic organopolysiloxanes having at least 2 alkenyl groups in the molecule. Examples of such organopolysiloxanes include divinyltetramethyldisiloxane, cyclotrimethyltrivinyltrisiloxane, cyclo-tetramethyltetravinyltetrasiloxane, hydroxy end-blocked polymethylvinylsiloxane, hydroxy terminated polymethylvinylsiloxane-co-polydimethylsiloxane, dimethylvinylsiloxy terminated polydimethylsiloxane, tetrakis(dimethylvinylsiloxy)silane and tris(dimethylvinylsiloxy)phenylsilane. Alternatively, compatibilizer (B″) is a hydroxy terminated polymethylvinylsiloxane [HO(MeViSiO)ₓH] oligomer having a viscosity of about 25-100 m Pa-s, containing 20-35% vinyl groups and 2-4% silicon-bonded hydroxy groups.

Compatibilizer (B′″) is a silane which contains at least one alkylene group, typically comprising vinylic unsaturation, as well as at least one silicon-bonded moiety selected from hydrolyzable groups or a hydroxyl group. Suitable hydrolyzable groups include alkoxy, aryloxy, acyloxy or amido groups. Examples of such silanes are vinyltriethoxysilane, vinyltrimethoxysilane, hexenyltriethoxysilane, hexenyltrimethoxy, methylvinyldisilanol, octenyltriethoxysilane, vinyltriacetoxysilane, vinyltris(2-ethoxyethoxy)silane, methylvinylbis(N-methylacetamido)silane, methylvinyldisilanol.

Compatibilizer (B″″) is an organopolysiloxane having at least one organofunctional groups selected from amine, amide, isocyanurate, phenol, acrylate, epoxy, and thiol groups. It is possible that a portion of the curable organopolysiloxane of the silicone base component (D) described infra, can also function as a compatibilizer. For example, a catalyst (C) can be used to first react a portion of the curable organopolysiloxane of silicone base (D) with the organic elastomer (A) to produce a modified organic elastomer. The modified organic elastomer is then further mixed with the remaining silicone base (D) containing the curable organopolysiloxane, and the organopolysiloxane is dynamically vulcanized as described infra.

In another chemical modification embodiment any organic elastomer can be selected as component (A) providing that the organic elastomer contains at least one group capable of reacting with at least a portion of the silicone compound. In other words, the organic elastomer should be capable of reacting with the silicone base via the operative cure mechanism selected for the organopolysiloxane. A cure agent (F) is added to the organopolysiloxane, component (D), and optionally crosslinker component (E), to cure the organopolysiloxane via a dynamic vulcanization process. Typically during the dynamic vulcanization process, i.e. step (II), the cure chemistry occurring at the surface of the silicone compound can also react with the organic elastomer, which furthers the dispersion of the silicone within the organic elastomer. Representative non-limiting examples of the reactive groups on the organic elastomer include methyl, methylene, vinyl, and halogens. For example, a methyl or methylene group on the organic elastomer could react with a peroxide, selected as the cure agent for the silicone compound, thus forming a bond between the organopolysiloxane and the organic elastomer. As another example, a vinyl group on the organic elastomer could react via the addition cure mechanism or radical cure mechanism.

In the “silicone compound” embodiment, depending on the type of modification, typically, the compatibilizer (B) can be added to the silicone compound.

The amount of compatibilizer used per 100 parts of organic elastomer can be determined by routine experimentation. Typically, 0.05 to 15 parts by weight, alternatively 0.05 to 10 parts by weight, or alternatively 0.1 to 5 parts of the compatibilizer is used for each 100 parts of organic elastomer.

(C) Catalyst

Optional component (C) is a catalyst. Typically, the catalyst is used in the chemically modified organic embodiment. As such, it is typically a radical initiator selected from any organic compound which is known in the art to generate free radicals at elevated temperatures. The initiator is not specifically limited and may be any of the known azo or diazo compounds, such as 2,2′-azobisisobutyronitrile, but it is preferably selected from organic peroxides such as hydroperoxides, diacyl peroxides, ketone peroxides, peroxyesters, dialkyl peroxides, peroxydicarbonates, peroxyketals, peroxy acids, acyl alkylsulfonyl peroxides and alkyl monoperoxydicarbonates. A key requirement, however, is that the half life of the initiator be short enough so as to promote reaction of compatibilizer (B) with the organic elastomer (A) within the time and temperature constraints of the preparation. The modification temperature, in turn, depends upon the type of organic elastomer and compatibilizer chosen and is typically as low as practical consistent with uniform mixing of components (A) through (C). Specific examples of suitable peroxides which may be used according to the method of the present invention include: 2,5-dimethyl-2,5-di(tert-butylperoxy)hexane; benzoyl peroxide; dicumyl peroxide; t-butyl peroxy O-toluate; cyclic peroxyketal; t-butyl hydroperoxide; t-butyl peroxypivalate; lauroyl peroxide; t-amyl peroxy 2-ethylhexanoate; vinyltris(t-butyl peroxy)silane; di-t-butyl peroxide, 1,3-bis(t-butylperoxyisopropyl) benzene; 2,2,4-trimethylpentyl-2-hydroperoxide; 2,5-bis(t-butylperoxy)-2,5-dimethylhexyne-3, t-butyl-peroxy-3,5,5-trimethylhexanoate; cumene hydroperoxide; t-butyl peroxybenzoate; and diisopropylbenzene mono hydroperoxide. Less than 2 part by weight of peroxide per 100 parts of organic elastomer is typically used. Alternatively, 0.05 to 1 parts, and 0.2 to 0.7 parts, can also be employed.

(D) Silicone Base, (E) Optional Crosslinker, and (F) Cure Agent

Component (D) is a silicone base comprising a curable organopolysiloxane (D′) and optionally, a filler (D″). A curable organopolysiloxane is defined herein as any organopolysiloxane having at least two curable groups present in its molecule. Organopolysiloxanes are well known in the art and are often designated as comprising any number of M units (R₃SiO_{0.5}), D units (R₂SiO), T units (RSiO_{1.5}), or Q units (SiO₂) where R is independently any monovalent hydrocarbon group. Alternatively, organopolysiloxanes are often described as having the following general formula, [RₘSi(O)_{4-m/2}]ₙ, where R is independently any monovalent hydrocarbon group and m=1-3, and n is at least two.

The organopolysiloxane in the silicone base (D) must have at least two curable groups in its molecule. As used herein, a curable group is defined as any organic or siloxane group that is capable of reacting with itself or another organic group, or alternatively with a crosslinker to crosslink the organopolysiloxane. This crosslinking results in a cured organopolysiloxane. Representative of the types of curable organopolysiloxanes that can be used in the silicone base are the organopolysiloxanes that are known in the art to produce silicone rubbers upon curing. Representative, non-limiting examples of such organopolysiloxanes are disclosed in “Encyclopedia of Chemical Technology”, by Kirk-Othmer, 4^{th} Edition, Vol. 22, pages 82-142, John Wiley & Sons, NY which is hereby incorporated by reference. Typically, organopolysiloxanes can be cured via a number of crosslinking mechanisms employing a variety of cure groups on the organopolysiloxane, cure agents, and optional crosslinking agent. While there are numerous crosslinking mechanisms, three of the more common crosslinking mechanisms used in the art to prepare silicone rubbers from curable organopolysiloxanes are free radical initiated crosslinking, hydrosilylation cure, and condensation cure. Thus, the curable organopolysiloxane can be selected from, although not limited to, any organopolysiloxane capable of undergoing any one of these aforementioned crosslinking mechanisms. The selection of components (D), (E), and (F) are made consistent with the choice of cure or crosslinking mechanisms. For example if hydrosilylation or addition cure is selected (herein referred as the “hydrosilylation cure embodiment’), then a silicone base comprising an organopolysiloxane with at least two vinyl groups (curable groups) would be used as component (D′), an organohydrido silicon compound would be used as component (E), and a platinum catalyst would be used as component (F). For condensation cure (“condensation cure embodiment”), a silicone base comprising an organopolysiloxane having at least 2 silicon bonded hydroxy groups or hydrolysable precursors of hydroxy groups (ie silanol or alkoxysilanes are considered as the curable groups) would be selected as component (D) and a condensation cure catalyst known in the art, such as a tin catalyst, would be selected as component (F). For free radical initiated crosslinking (“free radical cure embodiment”), any organopolysiloxane can be selected as component (D), and a free radical initiator would be selected as component (F) if the combination will cure within the time and temperature constraints of the dynamic vulcanization step (II). Depending on the selection of component (F) in such free radical initiated crosslinking, any alkyl group, such as methyl, can be considered as the curable groups, since they would crosslink under such free radical initiated conditions.

The quantity of the silicone phase, as defined herein as the combination of components (D), (E) and (F), used can vary depending on the amount of organic elastomer (A) used.

It is convenient to report the weight ratio of organic elastomer (A) to the silicone base (D) which typically ranges from 95:5 to 30:70, alternatively 90:10 to 40:60, alternatively 80:20 to 40:60.

In the hydrosilylation cure embodiment of the present invention, the selection of components (D), (E), and (F) can be made to produce a silicon rubber during the vulcanization process via hydrosilylation cure techniques. Thus, in the hydrosilylation cure embodiment, (D′) is selected from a diorganopolysiloxane gum which contains at least 2 alkenyl groups having 2 to 20 carbon atoms and optionally (D″), a reinforcing filler. The alkenyl group is specifically exemplified by vinyl, allyl, butenyl, pentenyl, hexenyl and decenyl, preferably vinyl or hexenyl. The position of the alkenyl functionality is not critical and it may be bonded at the molecular chain terminals, in non-terminal positions on the molecular chain or at both positions. Typically, the alkenyl group is vinyl or hexenyl and that this group is present at a level of 0.0001 to 3 mole percent, alternatively 0.0005 to 1 mole percent, in the diorganopolysiloxane. The remaining (i.e., non-alkenyl) silicon-bonded organic groups of the diorganopolysiloxane are independently selected from hydrocarbon or halogenated hydrocarbon groups which contain no aliphatic unsaturation. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; aryl groups having 6 to 12 carbon atoms, such as phenyl, tolyl and xylyl; aralkyl groups having 7 to 20 carbon atoms, such as benzyl and phenylethyl; and halogenated alkyl groups having 1 to 20 carbon atoms, such as 3,3,3-trifluoropropyl and chloromethyl. It will be understood, or course, that these groups are selected such that the diorganopolysiloxane has a glass temperature which is below room temperature and the cured polymer is therefore elastomeric. Typically, the non-alkenyl silicon-bonded organic groups in the diorganopolysiloxane makes up at least 85, or alternatively at least 90 mole percent, of the organic groups in the diorganopolysiloxanes.

Thus, polydiorganosiloxane (D′) can be a homopolymer, a copolymer or a terpolymer containing such organic groups. Examples include homopolymers comprising dimethylsiloxy units, homopolymers comprising 3,3,3-trifluoropropylmethylsiloxy units, copolymers comprising dimethylsiloxy units and phenylmethylsiloxy units, copolymers comprising dimethylsiloxy units and 3,3,3-trifluoropropylmethylsiloxy units, copolymers of dimethylsiloxy units and diphenylsiloxy units and interpolymers of dimethylsiloxy units, diphenylsiloxy units and phenylmethylsiloxy units, among others. The molecular structure is also not critical and is exemplified by straight-chain and partially branched straight-chain structures, the linear systems being the most typical.

Specific illustrations of diorganopolysiloxane (D′) include:
trimethylsiloxy-endblocked dimethylsiloxane-methylvinylsiloxane copolymers;
trimethylsiloxy-endblocked methylphenylsiloxane-dimethylsiloxane-methylvinylsiloxane copolymers; trimethylsiloxy-endblocked 3,3,3-trifluoropropylmethyl siloxane copolymers;
trimethylsiloxy-endblocked 3,3,3-trifluoropropylmethyl-methylvinylsiloxane copolymers;
dimethylvinylsiloxy-endblocked dimethylpolysiloxanes;
dimethylvinylsiloxy-endblocked dimethylsiloxane-methylvinylsiloxane copolymers;
dimethylvinylsiloxy-endblocked methylphenylpolysiloxanes;
dimethylvinylsiloxy-endblocked methylphenylsiloxane-dimethylsiloxane-methylvinylsiloxane copolymers; and similar copolymers wherein at least one end group is dimethylhydroxysiloxy.
   Typical systems for low temperature applications include methylphenylsiloxane-dimethylsiloxane-methylvinylsiloxane copolymers and diphenylsiloxane-dimethylsiloxane-methylvinylsiloxane copolymers, particularly wherein the molar content of the dimethylsiloxane units is about 85-95%.

The organopolysiloxane may also consist of combinations of two or more organopolysiloxanes. Alternatively, diorganopolysiloxane (D′) is a linear polydimethylsiloxane homopolymer and is preferably terminated with a vinyl group at each end of its molecule or it is such a homopolymer which also contains at least one vinyl group along its main chain.

For the purposes of the present invention, the preferred diorganopolysiloxane is a diorganopolysiloxane gum with a molecular weight sufficient to impart a Williams plasticity number of at least about 30 as determined by the American Society for Testing and Materials (ASTM) test method 926. Although there is no absolute upper limit on the plasticity of component (D′), practical considerations of processability in conventional mixing equipment generally restrict this value. Typically, the plasticity number should be 40 to 200, or alternatively 50 to 150.

Methods for preparing high consistency unsaturated group-containing diorganopolysiloxanes are well known and they do not require a detailed discussion in this specification.

Optional component (D″) is any filler which is known to reinforce diorganopolysiloxane (D′) and is preferably selected from finely divided, heat stable minerals such as fumed and precipitated forms of silica, silica aerogels and titanium dioxide having a specific surface area of at least about 50 m²/gram. The fumed form of silica is a typical reinforcing filler based on its high surface area, which can be up to 450 m²/gram. Alternatively, a fumed silica having a surface area of 50 to 400 m²/g, or alternatively 90 to 380 m²/g, can be used. The filler is added at a level of about 5 to about 150 parts by weight, alternatively 10 to 100 or alternatively 15 to 70 parts by weight, for each 100 parts by weight of diorganopolysiloxane (D′).

The filler is typically treated to render its surface hydrophobic, as typically practiced in the silicone rubber art. This can be accomplished by reacting the silica with a liquid organosilicon compound which contains silanol groups or hydrolyzable precursors of silanol groups. Compounds that can be used as filler treating agents, also referred to as anti-creping agents or plasticizers in the silicone rubber art, include such ingredients as low molecular weight liquid hydroxy- or alkoxy-terminated polydiorganosiloxanes, hexaorganodisiloxanes, cyclodimethylsilazanes and hexaorganodisilazanes.

Component (D) may also contain other materials commonly used in silicone rubber formulations including, but not limited to, antioxidants, crosslinking auxiliaries, processing agents, pigments, and other additives known in the art which do not interfere with step (II) described infra.

In the hydrosilylation cure embodiment of the present invention, compound (E) is added and is an organohydrido silicon compound (E′), that crosslinks with the diorganopolysiloxane (D′). The organohydrido silicon compound is an organopolysiloxane which contains at least 2 silicon-bonded hydrogen atoms in each molecule which are reacted with the alkenyl functionality of (D′) during the dynamic vulcanization step (II) of the present method. A further (molecular weight) limitation is that Component (E′) must have at least about 0.1 weigh percent hydrogen, alternatively 0.2 to 2 or alternatively 0.5 to 1.7, percent hydrogen bonded to silicon. Those skilled in the art will, of course, appreciate that either the diorganopolysiloxane (D′) or component (E′), or both, must have a functionality greater than 2 to cure the diorganopolysiloxane (i.e., the sum of these functionalities must be greater than 4 on average). The position of the silicon-bonded hydrogen in, component (E′) is not critical, and it may be bonded at the molecular chain terminals, in non-terminal positions along the molecular chain or at both positions. The silicon-bonded organic groups of component (E′) are independently selected from any of the saturated hydrocarbon or halogenated hydrocarbon groups described above in connection with diorganopolysiloxane (D′), including preferred embodiments thereof. The molecular structure of component (E′) is also not critical and is exemplified by straight-chain, partially branched straight-chain, branched, cyclic and network structures, network structures, linear polymers or copolymers being typical. It will, of course, be recognized that this component must be compatible with D′ (i.e., it is effective in curing the diorganopolysiloxane).

Component (E′) is exemplified by the following:
low molecular weight siloxanes such as PhSi(OSiMe₂H)₃;
trimethylsiloxy-endblocked methylhydridopolysiloxanes;
trimethylsiloxy-endblocked dimethylsiloxane-methylhydridosiloxane copolymers;
dimethylhydridosiloxy-endblocked dimethylpolysiloxanes;
dimethylhydrogensiloxy-endblocked methylhydrogenpolysiloxanes;
dimethylhydridosiloxy-endblocked dimethylsiloxane-methylhydridosiloxane copolymers;
cyclic methylhydrogenpolysiloxanes;
cyclic dimethylsiloxane-methylhydridosiloxane copolymers;
tetrakis(dimethylhydrogensiloxy)silane; trimethylsiloxy-endblocked methylhydridosiloxane polymers containing SiO_{4/2} units; silicone resins composed of (CH₃)₂HSiO_{1/2}, and SiO_{4/2} units;
silicone resins composed of (CH₃)₂HSiO_{1/2}, (CH₃)₃SiO_{1/2}, and SiO_{4/2} units; silicone resins composed of (CH₃)₂HSiO_{1/2} and CF₃CH₂CH₃SiO_{3/2}; and
silicone resins composed of (CH₃)₂HSiO_{1/2}, (CH₃)₃SiO_{1/2},
CH₃SiO_{3/2}, PhSiO_{3/2} and SiO_{4/2} units,
   wherein Ph hereinafter denotes phenyl radical.

Typical organohydrido silicon compounds are polymers or copolymers comprising RHSiO units terminated with either R₃SiO_{1/2} or HR₂SiO_{1/2} units wherein R is independently selected from alkyl radicals having 1 to 20 carbon atoms, phenyl or trifluoropropyl, typically methyl. Also, typically the viscosity of component (E′) is about 0.5 to 3,000 mPa-s at 25° C., alternatively 1 to 2000 mPa-s. Component (E′) typically has 0.5 to 1.7 weight percent hydrogen bonded to silicon. Alternatively, component (E′) is selected from a polymer consisting essentially of methylhydridosiloxane units or a copolymer consisting essentially of dimethylsiloxane units and methylhydridosiloxane units, having 0.5 to 1.7 weight percent hydrogen bonded to silicon and having a viscosity of 1 to 2000 mPa·s at 25° C. Such a typical system has terminal groups selected from trimethylsiloxy or dimethylhydridosiloxy groups. Alternatively, component (E′) is selected from copolymer or network structures comprising resin units. The copolymer or network structures units comprise RSiO_{3/2} units or SiO_{4/2} units, and may also contain R₃SiO_{1/2}, R₂SiO_{2/2}, and or RSiO_{3/2} units wherein R is independently selected from hydrogen or alkyl radicals having 1 to 20 carbon atoms, phenyl or trifluoropropyl, typically methyl. It is understood that sufficient R as hydrogen is selected such that component (E′) typically has 0.5 to 1.7 weight percent hydrogen bonded to silicon. Also, typically the viscosity of component (E′) is about 0.5 to 3,000 mPa-s at 25° C., alternatively 1 to 2000 mPa-s. Component (E′) may also be a combination of two or more of the above described systems.

The organohydrido silicon compound (E′) is used at a level sufficient to cure diorganopolysiloxane (D′) in the presence of component (F), described infra. Typically, its content is adjusted such that the molar ratio of SiH therein to Si-alkenyl in (D′) is greater than 1. Typically, this SiH/alkenyl ratio is below about 50, alternatively 1 to 20 or alternatively 1 to 12. These SiH-functional materials are well known in the art and many are commercially available.

In the hydrosilylation cure embodiment of the present invention, component (F) is a hydrosilation catalyst (F′) that accelerates the cure of the diorganopolysiloxane. It is exemplified by platinum catalysts, such as platinum black, platinum supported on silica, platinum supported on carbon, chloroplatinic acid, alcohol solutions of chloroplatinic acid, platinum/olefin complexes, platinum/alkenylsiloxane complexes, platinum/beta-diketone complexes, platinum/phosphine complexes and the like; rhodium catalysts, such as rhodium chloride and rhodium chloride/di(n-butyl)sulfide complex and the like; and palladium catalysts, such as palladium on carbon, palladium chloride and the like. Component (F′) is typically a platinum-based catalyst such as chloroplatinic acid; platinum dichloride; platinum tetrachloride; a platinum complex catalyst produced by reacting chloroplatinic acid and divinyltetramethyldisiloxane which is diluted with dimethylvinylsiloxy endblocked polydimethylsiloxane, prepared according to U.S. Pat. No. 3,419,593 to Willing; and a neutralized complex of platinous chloride and divinyltetramethyldisiloxane, prepared according to U.S. Pat. No. 5,175,325 to Brown et al., these patents being hereby incorporated by reference. Alternatively, catalyst (F) is a neutralized complex of platinous chloride and divinyltetramethyldisiloxane.

Component (F′) is added to the present composition in a catalytic quantity sufficient to promote the reaction between organopolysiloxane (D′) and component (E′) so as to cure the organopolysiloxane within the time and temperature limitations of the dynamic vulcanization step (II). Typically, the hydrosilylation catalyst is added so as to provide about 0.1 to 500 parts per million (ppm) of metal atoms based on the total weight of the elastomeric base composition, alternatively 0.25 to 50 ppm.

In another embodiment, components (D), (E), and (F) are selected to provide a condensation cure of the organopolysiloxane. For condensation cure, an organopolysiloxane having at least 2 silicon bonded hydroxy groups or hydrolysable precursors of hydroxy groups (i.e. silanol or alkoxysilanes are considered as the curable groups) would be selected as component (D), and a condensation cure catalyst known in the art, such as a tin catalyst, would be selected as component (F). The organopolysiloxanes useful as condensation curable organopolysiloxanes are one or more organopolysiloxanes which contains at least 2 silicon bonded hydroxy groups or groups that hydrolyze to silanol groups (SiOH) in its molecule. Typically, any of the organopolysiloxanes described infra as component (D) in the addition cure embodiment, can be used as the organopolysiloxane in the condensation cure embodiment if at least two SiOH or SiOH precursor groups are additionally present, although the alkenyl group would not be necessary in the condensation cure embodiment. A organohydrido silicon compound is useful as the optional crosslinking agent (E) is the same as described infra for component (E). However, more typically, the crosslinker is selected from a alkoxy or acetoxy endblocked organopolysiloxanes, that are known in the art for effecting condensation cure of organopolysiloxanes. The condensation catalyst useful as the curing agent in this embodiment is any compound which will promote the condensation reaction between the SiOH groups of diorganopolysiloxane (D) and the reaction between the SiOH groups of diorganopolysiloxane (D) and the SiH groups of organohydrido silicon compound (E)), when present, so as to cure the former by the formation of —Si—O—Si— bonds. Examples of suitable catalysts include metal carboxylates, such as dibutyltin diacetate, dibutyltin dilaurate, tin tripropyl acetate, stannous octoate, stannous oxalate, stannous naphthanate; amines, such as triethyl amine, ethylenetriamine; and quaternary ammonium compounds, such as benzyltrimethylammoniumhydroxide, beta-hydroxyethylltdmethylammonium-2-ethylhexoate and beta-hydroxyethylbenzyltrimethyldimethylammoniumbutoxide (see, e.g., U.S. Pat. No. 3,024,210).

In yet another embodiment, components (D), (E), and (F) can be selected to provide a free radical cure of the organopolysiloxane. In this embodiment, the organopolysiloxane can be any organopolysiloxane but typically, the organopolysiloxane has at least 2 alkenyl groups. Thus, any of the organopolysiloxane described supra as suitable choices for (D′) in the addition cure embodiment can also be used in the free radical embodiment of the present invention. A crosslinking agent (E) is not required, but may aid in the free radical cure embodiment. The cure agent (F) can be selected from any of the free radical initiators described supra for the selection of component (C).

(G) Optional Additive(s)

In addition to the above-mentioned major components (A) through (F), a minor amount (i.e., less than 50 weight percent of the total composition) of one or more optional additive (G) can be incorporated in the organic base elastomeric compositions of the present invention. These optional additives can be illustrated by the following non-limiting examples: extending fillers such as quartz, calcium carbonate, and diatomaceous earth; pigments such as iron oxide and titanium oxide; fillers such as carbon black and finely divided metals; heat stabilizers such as hydrated cerric oxide, calcium hydroxide, magnesium oxide; and flame retardants such as halogenated hydrocarbons, alumina trihydrate, magnesium hydroxide, wollastonite, organophosphorous compounds and other fire retardant (FR) materials. These additives are typically added to the final composition after dynamic cure, but they may also be added at any point in the preparation provided they do not interfere with the dynamic vulcanization mechanism. These additives can be the same, or different, as the additional components added to prepare the cured elastomeric compositions, described infra.

Mixing

The mixing of components (A) through (F), and optionally (G) in step (I) can be effected by any process known in the art for handling and mixing of elastomeric materials. Typical mixing techniques include, but not limited to mixers, extruders, Banbury mixers, kneaders or rolls. Alternatively, extrusion processes can be employed. Alternatively, the mixing steps (I) and the dynamic vulcanization step (II) of the present method can be accomplished by using a twin-screw extruder. Typically, the extrusion mixing process is conducted at a temperature range of 100 to 350° C., alternatively, 125 to 300° C., and yet alternatively 150 to 250° C. In one preferred embodiment of the present inventive method, the mixing is conducted on a twin-screw extruder in a time period of less than 3 minutes, or alternatively less than 2 minutes.

In the broadest aspect of the present invention, the order of mixing components (A) through (F) is not critical. Typically (G) would be added after (F) but it is not critical as long as (G) does not interfere with cure of the organopolysiloxane (e.g., (G) can be premixed with (A) the organic elastomer and/or with (D) the silicone base. However, in two embodiments described below the order of mixing may be specified.

The first embodiment of mixing comprises:

(I) mixing,
(A) an organic elastomer with
(B) a compatibilizer,
(C) an optional catalyst,

to form a modified organic elastomer; then mixing the modified organic elastomer with,
(D) a silicone base comprising a curable organopolysiloxane,
(E) an optional crosslinking agent,
(F) a cure agent in an amount sufficient to cure said organopolysiloxane.

The first step in this mixing embodiment produces a product, herein referred to as a “modified organic elastomer”. As used herein, the term “modified organic elastomer” refers to an organic elastomer that will produce an organic/silicone mixture having a continuous organic elastomer phase and a discontinuous (i.e. internal) silicone phase upon further mixing with a silicone base composition. The modified organic elastomer can be considered either as chemically modified or physically modified depending on the selection of components (A), (B), and optionally (C), and accompanying conditions used in this mixing step that are further delineated infra. In the embodiment of the present invention that prepares a chemically modified organic elastomer, components (A), (B), and optionally (C) are selected and mixed in such a manner to produce a reaction product of the organic elastomer and the compatibilizer. In the embodiment of the present invention that prepares a physically modified organic elastomer, components (A), (B), and optionally (C) are selected and mixed in such a manner to produce a physical mixture product of the organic elastomer and the compatibilizer. In either case, when the product of step (I) produces a modified organic elastomer, the organic elastomer (A) is modified in such a manner so as to produce an organic/silicone mixture which upon further mixing with a silicone base composition will produce a mixture having a continuous organic phase and a discontinuous (i.e. internal) silicone phase.

Components (D), (E), and (F) are then mixed with the “modified organic elastomer” according to any of the mixing techniques described herein.

The second embodiment of mixing comprises:

(I) mixing
(D) a silicone base comprising a curable organopolysiloxane,
(E) an optional crosslinking agent,
(F) a cure agent,

to form a silicone compound, then mixing the silicone compound with
(A) an organic elastomer,
(B) an optional compatibilizer, and
(C) an optional catalyst.

The second embodiment of mixing is characterized by first mixing the cure agent (F) with the silicone base (D) to form a silicone compound, prior to mixing with the organic elastomer (A). Accordingly, the organic elastomeric base composition is typically prepared by mixing the silicone compound with an organic elastomer (A), and optionally components (B) and (C) and then dynamically vulcanizing the organopolysiloxane of the silicone compound.

Dynamic Vulcanization

The second step (II) of the method of the present invention is dynamically vulcanizing the organopolysiloxane. The dynamic vulcanizing step cures the organopolysiloxane. Step (II) can occur simultaneous with the mixing step (I), or alternatively following the mixing step (I). Typically, step (II) occurs simultaneous with the mixing step (I), and is effected by the same temperature ranges and mixing procedures described for step (I).

Elastomeric Compositions

The present invention also relates to the organic elastomeric compositions prepared according to the methods taught herein, and further to the cured elastomeric compositions prepared therefrom. The inventors believe the techniques of the present invention provide unique and useful organic elastomeric compositions, as demonstrated by the inherent physical properties of the organic base elastomeric compositions, vs compositions of similar combinations of organic elastomers and silicone bases prepared by other methods or techniques. Furthermore, the cured organic elastomer compositions, as described infra, prepared from the organic base elastomeric compositions of the present invention also possess unique and useful properties. For example, cured organic elastomers prepared from the organic base elastomeric compositions of the present invention have surprisingly good low and high temperature properties and improved processability.

The cured organic elastomeric base compositions of the present invention can be prepared by curing the organic elastomer component of the organic elastomeric base composition of the present invention via known curing techniques. Curing of organic elastomers, and additional components added prior to curing, are well known in the art. Any of these known techniques, and additives, can be used to cure the organic elastomeric base compositions of the present invention and prepare cured organic elastomers therefrom.

Additional components can be added to the organic elastomeric base compositions prior to curing the organic elastomer component. These include blending other organic elastomers or other organic elastomeric base compositions into the organic elastomeric base compositions of the present invention. These additional components can also be any component or ingredient typically added to an organic elastomer or organic elastomer gum for the purpose of preparing a cured organic elastomer composition. Typically, these components can be selected from, fillers, processing aids, and curatives. Many commercially available organic elastomers can already comprise these additional components. Organic elastomers having these additional components can be used as component (A), described supra, providing they do not prevent the dynamic vulcanization of the silicone base in step (II) of the method of this invention. Alternatively, such additional components can be added to the organic elastomeric base composition prior to the final curing of the organic elastomer.

The cured organic elastomer composition may also comprise a filler. Examples of fillers include carbon black; coal dust fines; silica; metal oxides, e.g., iron oxide and zinc oxide; zinc sulfide; calcium carbonate; wollastonite, calcium silicate, barium sulfate, and others known in the art.

The cured organic elastomer compositions are useful in a variety of applications such as to construct various articles of manufacture illustrated by but not limited to O-rings, gaskets, seals, liners, hoses, tubing, diaphragms, boots, valves, belts, blankets, coatings, rollers, molded goods, extruded sheet, caulks, and extruded articles, for use in applications areas which include but not are limited to transportation including automotive, watercraft, and aircraft; chemical and petroleum plants; electrical: wire and cable: food processing equipment; nuclear power plants; aerospace; medical applications; and the oil and gas drilling industry and other applications which typically use high performance elastomers such as ECO, FKM, HNBR, acrylic rubbers and silicone elastomers.

### EXAMPLES

The following examples are presented to further illustrate the compositions and method of this invention. All parts and percentages in the examples are on a weight basis and all measurements were obtained at approximately 23° C., unless otherwise indicated.

Materials

CATALYST 1 is a 1.5% platinum complex of 1,3-diethenyl-1,1,3,3-tetramethyldisiloxane; 6% tetramethyldivinyldisiloxane; 92% dimethylvinyl ended polydimethylsiloxane and 0.5% dimethylcyclopolysiloxanes having 6 or greater dimethylsiloxane units.

DI-CUP R is 98-100% dicumyl peroxide (CAS# 80-43-3) marketed by Hercules, Inc. as DI-CUP® R.

DI-CUP 40C is 39.5-41.5% dicumyl peroxide (CAS# 80-43-3) supported on precipitated calcium carbonate marketed by Hercules, Inc. as DI-CUP® 40C.

EPDM 1 is a low-diene containing ethylene-propylene terpolymer (EPDM) and marketed by Dupont Dow Elastomers, LLC as Nordel®IP NDR 3640.00.

GP-50 is a silicone rubber base marketed by Dow Corning Corporation as Silastic® GP-50.

LCS-755 is a silicone rubber base marketed by Dow Corning Corporation as Silastic® (LCS-755.

TRIG 145PD is 2,5-dimethyl-2,5-di(tert-butylperoxy)hexyne (CAS# 78-63-7) marketed by Akzo Nobel Chemicals, Inc. as TRIGONOX® 145B-45PD.

VAROX is 2,5-dimethyl-2,5-di(tert-butylperoxy)hexane on an inert filler marketed by R.T. Vanderbilt, Company, Inc. as VAROX® DBPH-50.

Luperox F is di-(2-tert-butylperoxyisopropyl) benzene(s) and is marketed by Atofina Chemicals, Inc. as LUPEROX® F.

N774 is carbon black marketed by Cabot Corporation as Sterling® NS.

Austin Black is a ground coal marketed by Coal Fillers Incorporated as Austin Blacks® 325.

Ricon 150 is a Polybutadiene (CAS # 9003-17-2) and marketed by Sartomer Company as Ricon® 150.

X-LINKER 1 is Dow Corning® 6-3570, a trimethylsiloxy-terminated, dimethyl, methylhydrogen siloxane, having a viscosity of 5 cSt, and 0.76 wt % hydrogen on silicon.

Testing

The tensile, elongation, and 100% modulus properties of the cured elastomeric base compositions were measured by a procedure based on ASTM D 412. Shore A Durometer was measured by a procedure based on ASTM D 2240.

### Example 1

GP-50 (60 g) and Luperox F (0.2 g) were mixed on a 2-roll mill to form a silicone compound. This silicone compound and EPDM (140 g) were added to a 379 ml Haake mixer equipped with banbury rotors at 150° C. and 125 rpm (revolutions per minute). After about 8 minutes and a torque increase, the material temperature was about 200° C. The elastomeric base composition was removed at 12 minutes.

Upon cooling, the resulting elastomeric base composition (50 g) composition was compounded on a 2-roll mill with Dicup R (1 g) and N774 (17.5 g) and components were mixed until homogenous.

### Example 2

GP-50 (60 g), Luperox F (0.2 g), and Ricon 150 (0.3 g) were mixed on a 2-roll mill to form a silicone compound. The silicone compound and EPDM (140 g) were added to a 379 ml Haake mixer equipped with banbury rotors at 150° C. and 125 rpm (revolutions per minute). After about 8 minutes and a torque increase, the material temperature was about 200° C. The elastomeric base composition was removed at 12 minutes.

Upon cooling, the resulting elastomeric base composition (50 g) composition was compounded on a 2-roll mill with Dicup R (1 g) and N774 (17.5 g) and components were mixed until homogenous.

### Example 3

LCS-755 (100 parts), Catalyst 1 (0.22 parts), ETCH (0.23 parts) and X-LINKER 1 (1.5 parts) were mixed on a 2-roll mill to form a silicone compound. The silicone compound (60 g) and EPDM (140 g) were added to a 379 ml Haake mixer equipped with banbury rotors at 150° C. and 125 rpm (revolutions per minute). After about 8 minutes and a torque increase, the material temperature was about 200° C. The elastomeric base composition was removed at 12 minutes.

Upon cooling, the resulting elastomeric base composition (50 g) composition was compounded on a 2-roll mill with Dicup R (1 g) and N774 (17.5) and components were mixed until homogenous.

Examples 1-3 were pressed cured at 177° C. for 10 minutes. The physical properties of the resulting cured elastomeric base compositions are summarized in Table 1.

TABLE 1

| | Example # | | |
|---|---|---|---|
| | 1 | 2 | 3 |
| Shore A Durometer | 59 | 61 | 63 |
| Tensile strength, MPa | 12.6 | 11.2 | 9.4 |
| Elongation, % | 228 | 201 | 246 |

### Example 4

EPDM (140 g), DI-CUP 40C (0.3 g) and Ricon 150 (0.3 g) were added to a 379 ml Haake mixer equipped with banbury rotors at 120° C. and 125 rpm (revolutions per minute). After about 3 minutes, the material temperature was about 160° C. GP-50 (60 g) then Luperox F (0.2 g) were added. After about 11 minutes and a torque increase, the temperature was over 200° C. The elastomeric base composition was removed at 15 minutes.

Upon cooling, the resulting elastomeric base composition (50 g) composition was compounded on a 2-roll mill with DI-CUP R (1 g) and N774 (17.5 g) and components were mixed until homogenous. The cured elastomeric base composition had a Shore A Durometer of 60, a Tensile Strength of 11.7 MPa, and an Elongation of 202%.

### Example 5

Three fluorocarbon base elastomeric compositions were prepared using a 25 mm Werner and Pfleiderer twin-screw extruder with the processing sections heated at 150° C. and 180° C. and a screw speed of 500 rpm. LCS-755 (100 parts), ZnO (5 parts), and Varox (0.5 parts) were first mixed to form a silicone compound. For Sample A, the extruder feed rate was 174 grams/minute for the organic elastomer EPDM 1 and 160 grams/minute for the silicone compound. For Sample B, the respective rates were 106 grams/minute and 225 grams/minute. For Sample C, the respective rates were 72 grams/minute and 147 grams/minute. The resulting organic elastomeric compositions obtained from the extruder were compounded with 7 parts of DI-CUP 40C, and 15 parts of Austin Black per 100 parts of EPDM 1. The samples were press cured for 10 minutes at 177° C. Sample A had a Shore A Durometer of 54, a Tensile Strength of 5.3 Mpa and an Elongation of 229%. Sample B had a Shore A Durometer of 53, Tensile Strength of 5.7 MPa, and an Elongation of 209%. Sample C had a Shore A Durometer of 52, a Tensile Strength of 5.3 Mpa and an Elongation of 205%.

1. A method for preparing an elastomeric base composition comprising:
(I) mixing
(A) an organic elastomer with
(B) an optional compatibilizer,
(C) an optional catalyst,
(D) a silicone base comprising a curable organopolysiloxane,
(E) an optional crosslinking agent,
(F) a cure agent in an amount sufficient to cure said organopolysiloxane; and
(II) dynamically vulcanizing the organopolysiloxane,
wherein the weight ratio of organic elastomer (A) to silicone base (D) in the elastomeric base composition ranges from 95:5 to 30:70.

2. The method of claim 1 wherein the mixing is performed by an extrusion process.

3. The method of claim 1 wherein:
(A) an organic elastomer
(B) a compatibilizer,
(C) an optional catalyst,
are first mixed to form a modified organic elastomer; then the modified organic elastomer is mixed with,
(D) a silicone base comprising a curable organopolysiloxane,
(E) an optional crosslinking agent,
(F) a cure agent in an amount sufficient to cure said organopolysiloxane.

4. The method of claim 1 wherein:
(D) a silicone base comprising a curable organopolysiloxane,
(E) an optional crosslinking agent,
(F) a cure agent,
are first mixed to form a silicone compound; then the silicone compound is mixed with,
(A) an organic elastomer,
(B) an optional compatibilizer, and
(C) an optional catalyst.

5. The method of claim 1 wherein the organic elastomer is selected from natural rubber (NR), isoprene rubber (IR), styrene-butadiene rubber (SBR), butadiene rubber (BR), chloroprene rubber (CR), chlorinated polyethylene (CPE), butyl rubber, acrylonitrile-butadiene rubber (NBR), chlorosulfonated polyethylene (CSM), acrylic rubber (ACM), epichlorohydrin rubber (ECO), ethylene-vinyl acetate rubber (EVM), ethylene-acrylic rubber, ethylene-α-olefin copolymerized rubber, ethylene-α-olefin-diene terpolymerized rubber (EPDM), or hydrogenated nitrile rubber (HNBR).

6. The method of claim 1 wherein the catalyst (C) is present and is an organic peroxide selected from a hydroperoxide, diacyl peroxide, ketone peroxide, peroxyester, dialkyl peroxide, peroxydicarbonate, peroxyketal, peroxy acid, acyl alkylsulfonyl peroxide and alkyl monoperoxydicarbonate.

7. The method of claim 1 wherein the silicone base is a diorganopolysiloxane gum with a Williams plasticity number of at least about 30 as determined by the American Society for Testing and Materials (ASTM) test method 926.

8. The method of claim 1 wherein the cure agent (F) is present and is an organic peroxide selected from a hydroperoxide, diacyl peroxide, ketone peroxide, peroxyester, dialkyl peroxide, peroxydicarbonate, peroxyketal, peroxy acid, acyl alkylsulfonyl peroxide and alkyl monoperoxydicarbonate.

9. A product produced according to the method of claim 1.

10. A cured elastomeric composition comprising the product of claim 9.

11. An article of manufacture comprising the product of claim 9.
